(19) United States
(12) Patent Application Publication
(10) Pub. No.: US 2026/0251229 A1
(43) Pub. Date: Aug. 27, 2026

(54) INFLATION VALVE ASSEMBLY

(71) Applicant: PURPLE LINE LIMITED, Ipswich (GB)

(72) Inventors: Jonathan Harrison, Ipswich (GB); James Payne, Ipswich (GB); Brett Skingle, Ipswich (GB)

(73) Assignee: PURPLE LINE LIMITED, Ipswich (GB)

(21) Appl. No.: 19/163,120

(22) PCT Filed: Mar. 8, 2024
(86) PCT No.: PCT/GB2024/050638

§ 371 Date: Sep. 8, 2025

(30) Foreign Application Priority Data
Mar. 10, 2023 (GB) 2303561.1

(51) Int. Cl. F16K 15/20; E04H 15/20; F16K 15/18; F16K 31/08

(52) U.S. Cl. CPC F16K 15/20; F16K 15/182; F16K 31/086; E04H 15/20

(57) ABSTRACT

The present invention provides an inflation valve assembly for an inflatable camping assembly which may comprise an awning, a tent or an inflatable camping accessory (mattress, chair, furniture etc.). The inflation valve assembly comprises an inflation valve (20) comprising an inlet (22) and an outlet (24). In order to inflate the camping assembly, an air source (e.g. pump) is connected to the inlet (22) to introduce air through the outlet (24) into a chamber within the camping assembly. The valve member comprises a seal member (26) which seals the air pathway between the inlet (22) and the outlet (24) to retain the air pressure within the chamber. However, the seal member (26) is movable from this closed position to an open position whilst the air source is connected to the inlet (22) and/or to allow the chamber to be deflated. The present invention provides a valve key (60) which allows the authorised movement of the seal member (26) from the closed position to the open position. Without the use of this valve key (60), the seal member (26) is retained in the closed position.

### FIELD OF THE INVENTION

The present invention relates to an inflation valve assembly comprising a valve key. In particular, the present invention relates to an inflatable camping assembly comprising an inflation valve and a valve key.

### BACKGROUND TO THE INVENTION

Tents, folding campers such as camper trailers, and camping accessories such as awnings or gazebos may be complex or time consuming to erect, for example when these structures have to be assembled from a number of parts. Such parts may be easily damaged during assembly or in use, for instance by impacts or high winds. To address these problems, these structures may comprise inflatable parts, which allow the structures to be erected by inflating the inflatable parts using a source of pressurised air, such as a pump.

The inflatable assemblies may include several inflation valves with individual stoppers/sealing arrangements. Such stoppers have to be manually placed and secured within the inflation valve to allow for the inflation of the assembly. Accordingly, users may need to check that all of the inflation valves are correctly closed prior to inflating the assembly. With large camping assemblies it can be difficult to lay out the deflated assembly and locate all of the inflation valves in order to check that they are closed. This may delay the erecting of the camping assembly which may be during a period of bad weather, e.g. raining where internal walls/surfaces may become wet. In addition, it may be easy to miss an inflation valve and to commence inflating the assembly which will lead to air simultaneously escaping as the assembly is inflated. This is inefficient and may take time for the user to realise what is happening. This can be especially problematic with a new or unfamiliar camping assembly where're the user will not be aware of the location or number of inflation valves. The use of a single inflation/deflation valve may result in a user being able to ensure that no air escape during inflation but this may result in a prolonger deflation period since the air will only be able to escape from a single location. Furthermore, air is more likely to be trapped such that the deflated assembly is not easy to pack up an a compact arrangement and/or into the dedicated bag/container.

In addition, a disadvantage of using inflatable parts is that such inflatable parts may be easily deflated, for example by an unauthorised person. Such deflation may be performed by any person and at any time, for example during the night. This may not only be a nuisance for the occupant but may also create anxiety for the owners and/or occupants of such inflatable structures.

In addition, inflation valves generally provide a universal inflation valve which may try and accommodate any or a number of inflation devices/pumps. However, the attempt to accommodate a variety of such attachments may be detrimental to the seal and retention of the inflation devices to the inflation valve and, specifically, the seal between pump adaptors and the inflation valve. A user may be required to continuously hold the adaptor within the valve or may need to periodically push the adaptor back into the inflation valve to maintain an open air pathway.

It is an object of the present invention to overcome at least one problem associated with the prior art, whether referred to herein or otherwise.

### SUMMARY OF THE INVENTION

According to a first aspect of the present invention there is provided an inflation valve assembly comprising:
an inflation valve comprising:
   an inlet;
   an outlet; and
   a seal member which is movable between an open position and a closed position, the seal member comprising a seal to prevent or allow air flow through inflation valve between the inlet and the outlet, the seal member being biased away from the open position and towards the closed position by bias means;
a valve key;
wherein the valve key is configured to be docked with the inlet of the inflation valve to move the seal member to the open position and engagement means are arranged to engage the valve key in this docked position, in the docked position the valve key maintains the seal member in the open position to create an air pathway through the inflation valve between the inlet and the outlet.

Preferably the inflation valve assembly comprise a magnetic docking arrangement to retain the valve key to the inflation valve and to move the seal member from the closed position to the open position. The default position of the inflation valve/seal member is in a closed position and is (only/solely) moved to (and retained in) an open position due to the docking of the valve key with the inflation valve.

Preferably the valve key comprises a magnetic key member. The magnetic key member may be located centrally on a docking face of the valve key. The magnetic key member may comprise a magnetic core. The magnetic key member may comprise a permanent magnet.

The valve key may have a substantially circular docking face.

The valve key may comprise a disc member.

The valve key may comprise a cylindrical body. The valve key may comprise a partition member having a series of openings defined therethrough. The openings may be defined (evenly) spaced around the central magnetic member.

The valve key may have further face for connection with an air source. Additionally or alternatively, the further face may be left exposed to allow air to pass through the inflation valve and out through the further face of the valve key.

The valve key may comprise a seal member to create a seal against the inflation valve. Preferably the docking of the valve key with the inlet of the inflation valve causes the seal member to create a seal between the inflation valve and the valve key.

The valve key may comprise a first docking face and a second docking face on opposing sides of the valve key. Each docking face may be shaped and/or dimensioned to dock with an inlet of different sized and/or shaped inflation valves.

The valve key may comprise two seal members which may be provided on each docking face of the valve key.

The inflation valve may comprise a magnetic valve member. The magnetic valve member may be arranged to attract a magnetic key member of the valve key in order to dock the valve key with the inlet of the inflation valve. The magnetic key member and the magnetic valve member may provide a magnetic latch to retain the valve key to the inflation valve.

Preferably the magnetic valve member is provided on the seal member. Preferably the magnetic valve member is located with a carrier of the seal member. The latching of the magnetic valve member with the magnetic key member may move the seal member from the closed position to the open position. In the closed position, the seal member may seal an opening of the outlet of the inflation valve. The seal member may comprise a seal to seal over and/or around the opening of the outlet. The seal member may comprise a sealing disc which may comprise an elastomeric sealing disc. The seal member may comprise a secondary seal to seal around the opening of the outlet of the inflation valve.

The bias means may comprise a magnetic bias arrangement to bias the seal member towards the closed position. The magnetic bias arrangement may comprise first magnetic means in a housing of the inflation valve. The magnetic bias arrangement may comprise second magnetic means provided on the seal member.

Accordingly, the magnetic bias arrangement may retain the seal member in the closed position unless a counteracting force is greater than the magnetic strength of the magnetic bias arrangement. Preferably the strength of the magnetic docking arrangement is greater than the strength of the magnetic bias arrangement.

The first magnetic means may comprise a permanent magnet and preferably comprises a series of permanent magnets. The or each permanent magnet may be embedded or housed within a corresponding recess in the housing. The recess(es) may be defined in a sealing surface of the housing. The or each permanent magnet may comprise a disc magnet.

The second magnetic means may comprise a ferrous member or members. The second magnetic means may comprise a ferrous washer. The second magnetic means may be secured in or to the carrier of the seal member.

The inflation valve may comprise a restrictor to limit the movement of the seal member away from an opening of the outlet of the inflation valve. Accordingly, the seal member may be limited to move between a sealing surface and the restrictor. The seal member may be limited in a first direction by a sealing surface and by the restrictor in the second (opposite) direction. The restrictor may comprise an opening or a series of openings to allow air to flow therethrough.

The bias means may comprise a spring bias arrangement comprising spring means to bias the seal member towards the closed position.

The spring may comprise a single coiled spring which may locate between a proximal (upper) facing surface of the carrier and a distal (lower) facing surface of the restrictor.

The spring may comprise a resiliently deformable member.

The spring may comprise a leaf spring. The spring may comprise a plurality of leaf springs, for example two leaf springs. The or each leaf spring may be arcuate and may extend around 180 degrees. A first end of the leaf spring may be attached or secured to a distal (lower) facing surface of the restrictor and a free end of the or each leaf spring may extend distally and may be arranged t abut a proximal (upper) facing surface to urge the seal member towards the closed position.

The spring may locate around a central core of the carrier. Accordingly, the spring bias arrangement may retain the seal member in the closed position unless a counteracting force is greater than the spring strength of the spring bias arrangement. Preferably the strength of the magnetic docking arrangement is greater than the strength of the spring bias arrangement. The magnetic strength of the magnetic docking arrangement may be sufficient to compress the spring.

The bias means may comprise a fluid chamber. The fluid chamber may have a first end which may be acted on by a part of the valve key. The first end may comprise a membrane. The second end of the fluid chamber may be in communication with the seal member. Accordingly, pressure from the valve key at the first end of the chamber is transmitted through the fluid within the chamber and acts of the seal member.

The seal member may comprise a cap. The cap may have one or a plurality of openings defined around a skirt. The cap may be arranged to locate over a corresponding tube section of the outlet. In the closed position, the or each opening locates adjacent to an outer periphery of the tube section and in the open position the or each opening locates above a proximal (upper) edge of the tube section.

The docking arrangement may comprise a bayonet mechanism. The inflation valve may comprise one or two or more slots for engagement with one or two or more lugs provided on an external/outer surface of the valve key.

The docking arrangement may comprise an interference fit.

The seal member may comprise a sealing disc with flaps which are moveable from a closed position to an open position. The sealing disc may comprise four sealing flaps. The valve key may comprise a nozzle to urge the flaps to move apart to create an opening through the sealing disc when the valve key is docked with the inlet.

The inflation valve may comprise a shape memory device. The shape memory device may be arranged to move the seal member from the closed position to the open position. Preferably the shape memory device is arranged to move the seal member from the closed position to the open position when the valve is docked with the inlet. The shape memory device may comprise a shape memory alloy. The shape memory device may comprise a helical member which is arranged to expand on activation by the valve key. The valve key may comprise activation means for the shape memory device. The docking of the valve key may cause the shape memory device to heat up and expand. Removal of the valve key may cause the shape memory device to cool down and for the shape memory device to compress/retract.

The seal member may comprise a disc having one or more openings therethrough. A distal (lower) surface of the seal member may comprise a sealing material, for example an elastomeric. The distal (lower) surface may be arranged to be lifted (or raised) away from a sealing surface to enable air to flow between an opening for the outlet though the or each opening and out of the inlet.

The inflation valve assembly may comprise a second inflation valve whereby the valve key is arranged to be docked with the first inflation valve and also with the second inflation valve. A first side of the valve key may dock with a first inflation valve and a second side of the valve key may dock against a second inflation valve.

The default configuration of the inflation valve is a closed configuration.

According to a second aspect of the present invention there is provided a camping assembly comprising an inflatable camping assembly comprising an inflation valve assembly comprising:
an inlet;
an outlet; and
a seal member which is movable between an open position and a closed position, the seal member comprising a seal to prevent or allow air flow through inflation valve between the inlet and the outlet, the seal member being biased away from the open position and towards the closed position by bias means;
   the camping assembly further comprising a valve key;
wherein the valve key is configured to be docked with the inlet of the inflation valve to move the seal member to the open position and engagement means are arranged to engage the valve key in this docked position, in the docked position the valve key maintains the seal member in the open position to create an air pathway through the inflation valve between the inlet and the outlet.

The inflatable camping assembly may comprise an inflatable tent or awning or gazebo. The inflatable camping assembly may comprise an inflatable camper trailer tent.

The camping assembly may comprise a second inflatable camping assembly. The second inflatable camping assembly may comprise an inflatable tent or awning or gazebo.

The first and/or the second inflatable camping assembly may comprise a gazebo, a wind break, an auxiliary tent, an inflatable paddling pool, an inflatable ball, an inflatable mattress and/or an inflatable seat (such as chair or sofa).

The first inflation valve assembly may comprise a first interconnecting valve and the second inflation valve may comprise a second interconnecting valve.

The valve key may be arranged to be docked to both the first inflation valve and the second inflation valve. The valve key may be arranged to move and retain a seal member of the first inflation valve in an open position and a seal member of the second inflation valve in an open position.

According to a third aspect of the present invention there is provided a method if inflating an inflatable camping assembly, the inflatable camping assembly comprising an inflation valve assembly comprising:
an inflation valve comprising:
   an inlet;
   an outlet; and
   a seal member which is movable between an open position and a closed position, the seal member comprising a seal to prevent or allow air flow through inflation valve between the inlet and the outlet, the seal member being biased away from the open position and towards the closed position by bias means;
a valve key;
wherein the valve key is configured to be docked with the inlet of the inflation valve to move the seal member to the open position and engagement means are arranged to engage the valve key in this docked position, in the docked position the valve key maintains the seal member in the open position to create an air pathway through the inflation valve between the inlet and the outlet;
the method comprising docking and engaging the valve key with the inlet of the inflation valve and moving the seal member to an open position.

The method may comprise docking an air source with the valve key. The method may comprise supplying air from the air source through the valve key and through the inflation valve to the inflatable camping assembly.

The air source may comprise a second/auxiliary inflatable camping assembly. The method may comprise docking the valve key with an inflation valve on the second/auxiliary inflatable camping assembly. The method may comprise donating or transferring air from the second inflatable camping assembly through the inflation valve assembly and to the first inflatable camping assembly. The transfer or donation may be through a second inflation valve then through the valve key and then through the first inflation valve.

### BRIEF DESCRIPTION OF THE DRAWINGS

The present invention will now be described, by way of example only, with reference to the accompanying drawings, in which:

FIGS. 1a, 1b, 1c and 1d are a perspective view, a perspective cross section, a side cross section and an exploded view respectively of a first preferred embodiment of an inflation valve;

FIG. 2 is an exploded view of a first preferred embodiment of a valve key;

FIGS. 3a, 3b and 3c are a perspective view, a perspective cross section and a side cross section of a first preferred embodiment of an inflation valve assembly comprising an inflation valve and a valve key;

FIGS. 4a, 4b, 4c and 4d are a perspective view, a perspective cross section, a side cross section and an exploded view respectively of a second preferred embodiment of an inflation valve;

FIG. 5 is an exploded view of a second preferred embodiment of a valve key;

FIGS. 6a, 6b and 6c are a perspective view, a perspective cross section and a side cross section of a second preferred embodiment of an inflation valve assembly comprising an inflation valve and a valve key;

FIGS. 7a, 7b, 7c and 7d are a perspective view, a perspective cross section, a side cross section and an exploded view respectively of a third preferred embodiment of an inflation valve;

FIG. 8 is an exploded view of a third preferred embodiment of a valve key;

FIGS. 9a, 9b and 9c are a perspective view, a perspective cross section and a side cross section of a third preferred embodiment of an inflation valve assembly comprising an inflation valve and a valve key;

FIGS. 10a, 10b, 10c and 10d are a perspective view, a perspective cross section, a side cross section and an exploded view respectively of a fourth preferred embodiment of an inflation valve;

FIG. 10e is a perspective view of a distal/underside of an embodiment of a restrictor of the further preferred embodiment of an inflation valve;

FIG. 11 is an Exploded View of a Fourth Preferred Embodiment of a Valve Key;

FIGS. 12a, 12b and 12c are a perspective view, a perspective cross section and a side cross section of a fourth preferred embodiment of an inflation valve assembly comprising an inflation valve and a valve key;

FIGS. 13a, 13b, 13c and 13d are a perspective view, a perspective cross section, a side cross section and an exploded view respectively of a fifth preferred embodiment of an inflation valve;

FIG. 14 is an exploded view of a fifth preferred embodiment of a valve key;

FIGS. 15a, 15b and 15c are a perspective view, a perspective cross section and a side cross section of a fifth preferred embodiment of an inflation valve assembly comprising an inflation valve and a valve key;

FIGS. 16a, 16b, 16c and 16d are a perspective view, a perspective cross section, a side cross section and an exploded view respectively of a sixth preferred embodiment of an inflation valve;

FIG. 17 is an exploded view of a sixth preferred embodiment of a valve key;

FIGS. 18a, 18b and 18c are a perspective view, a perspective cross section and a side cross section of a sixth preferred embodiment of an inflation valve assembly comprising an inflation valve and a valve key;

FIGS. 19a, 19b, 19c and 19d are a perspective view, a perspective cross section, a side cross section and an exploded view respectively of a seventh preferred embodiment of an inflation valve;

FIG. 20 is an exploded view of a seventh preferred embodiment of a valve key;

FIGS. 21a, 21b and 21c are a perspective view, a perspective cross section and a side cross section of a seventh preferred embodiment of an inflation valve assembly comprising an inflation valve and a valve key;

FIGS. 22a, 22b and 22c are a perspective view, a cross-section of a further embodiment of an inflation valve and a cross section of part of a further embodiment of an inflation valve;

FIGS. 23a and 23b are cross sections of the further embodiments of the inflation valve in a default closed position/configuration and an open position/configuration respectively;

FIGS. 24a, 24b, and 24c are perspective views of an embodiment of a valve assembly including two inflation valves and a single valve key wherein, in FIG. 24a both inflation valves are in the default closed position, in FIG. 24b one inflation valve is in the open position and one is in the closed position, and in FIG. 24c both inflation valves are in the open position; and

FIGS. 25a, 25b, 25c and 25d are a perspective view, a perspective cross section, a side cross section and an exploded view respectively of another preferred embodiment of an inflation valve;

FIGS. 26a, 26b and 26c are a perspective view, a perspective cross section and a side cross section of another preferred embodiment of an inflation valve assembly comprising an inflation valve and a valve key;

FIG. 27 is a perspective view of another preferred embodiment of a valve key.

### DESCRIPTION OF THE PREFERRED EMBODIMENTS

The present invention provides an inflation valve assembly 10 for an inflatable camping assembly which may comprise an awning, a tent or an inflatable camping accessory (mattress, chair, furniture etc.). The inflation valve assembly comprises an inflation valve 20 comprising an inlet 22 and an outlet 24. In order to inflate the camping assembly, an air source (e.g. pump) is connected to the inlet 22 to introduce air through the outlet 24 into a chamber within the camping assembly. For example, the chamber may be provided within an air pole of a tent or awning. The valve member comprises a seal member 26 which seals the air pathway between the inlet 22 and the outlet 24 to retain the air pressure within the chamber. However, the seal member 26 is movable from this closed position to an open position whilst the air source is connected to the inlet 22 and/or to allow the chamber to be deflated. The present invention provides a valve key 60 which allows the authorised movement of the seal member 26 from the closed position to the open position. Without the use of this valve key 60, the seal member 26 is retained in the closed position. This prevents the unauthorised deflation of the inflatable camping assembly. In addition, the retention of the valve key 60 within the inlet 22 facilitates the deflation of the camping assembly by maintaining the seal member 26 in the open position without the need to continuously manually manipulate a part of the inflation valve (e.g. manually holding a pump adaptor within the inflation valve).

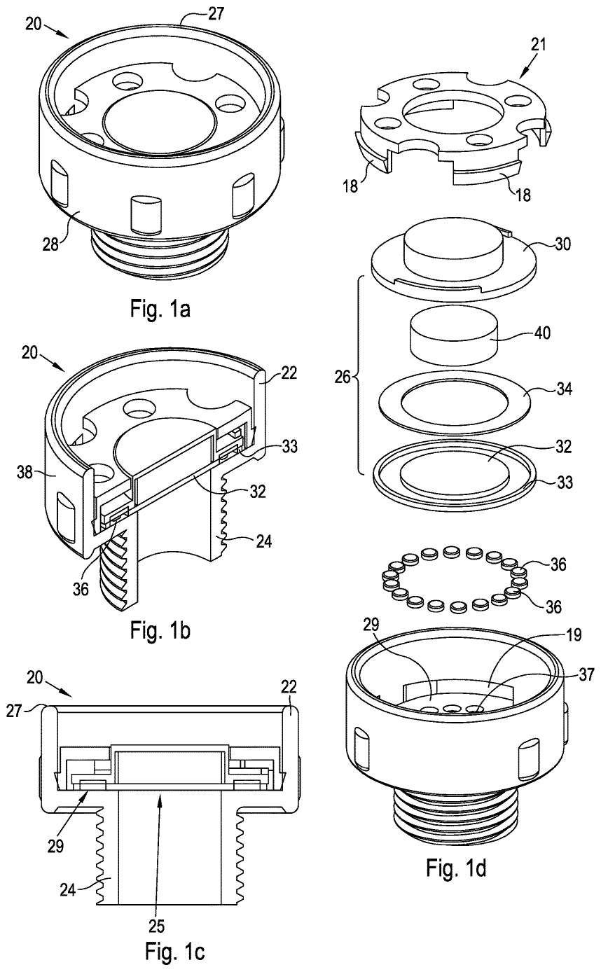

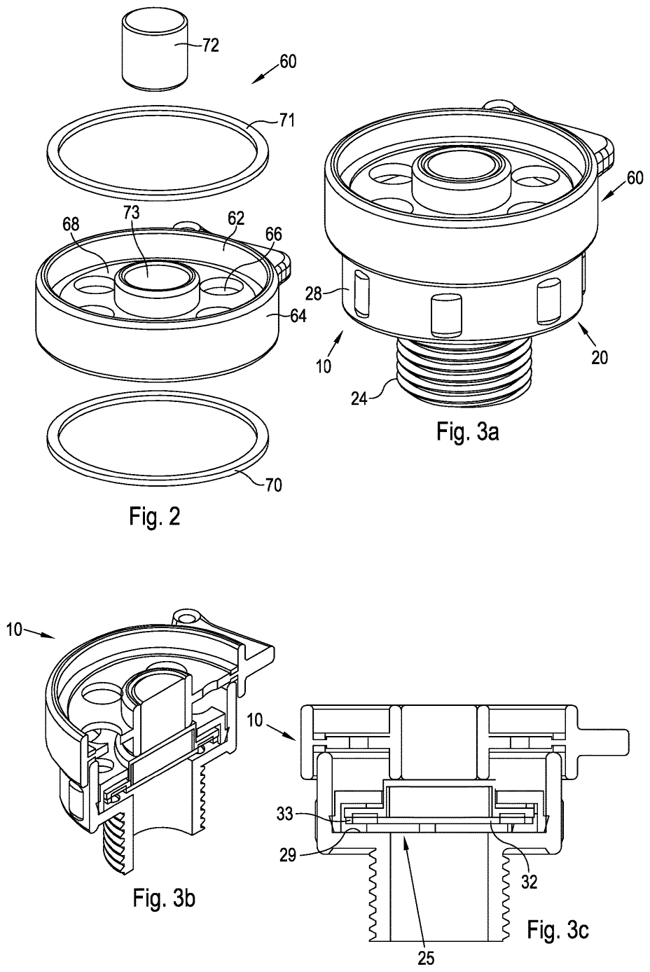

As shown in FIG. 1 to FIG. 3, a first embodiment of the valve assembly 10 comprises an inflation valve 20 and dedicated valve key 60. The valve key comprises a magnet 62 to move the seal member 26 from the closed position to the open position. In addition, the magnet 62 is arranged to automatically retain the valve key within the inlet 22.

The seal member 26 of the inflation valve 20 comprises a carrier 30 and a restrictor 31 which secures the carrier 30 within the inlet 22. The seal member 26 also comprises a seal which in this embodiment comprises a primary seal 32 and a secondary seal 33. The primary seal 32 comprises a central seal which is arranged to seal against a sealing surface 29 defined around an opening 25 of the outlet 24. The secondary seal 33 comprises an annular seal which provides a secondary seal and, in the closed position, again seals against the sealing surface 29 provided by a valve housing 28 of the inflation valve 20. The primary and secondary seals 32, 33 are both secured to a distal surface provided on the carrier 30.

The seal member 26 also comprises a magnetic member 34 in the form of an annular component, which in this embodiment comprises a ferrous washer. The inflation valve 20 comprise magnetic means which is arranged to cooperate with the magnetic member 34 of the seal member 26. Specifically magnetic means are located within the housing 28 of the inflation valve 20 in direct opposition with the magnetic member 34 of the seal member 26. The magnetic means comprises a series of individual magnets 36 which are embedded and/or secured within the housing 28. The housing 28 is provided with a series of individual openings 37 for the magnets 36. These openings 37 are provided in the sealing surface 29 of the housing 28.

The individual magnets 36 thereby attracts the magnetic member 34 of the seal member 26 in order to attract and move the seal member 26 towards the sealing surface 29. Specifically, this biasing arrangement causes the primary and secondary seals 32, 33 to seal against the sealing surface 29. The magnetic attractive force will set the pressure which can be contained by the inflation valve 20. For example, if the pressure within the pressurised chamber exceeds a specific pressure, then the pressure acting on the central area (primarily on the primary seal 32) may be sufficient to move the magnetic member 34 away from the individual magnets. This will open up an air pathway between the outlet 24 and the inlet 22 and will provide an air escape pathway.

The restrictor 21 of the inflation valve 20 is arranged to restrict the movement of the seal member 26. Specifically, the restrictor 21 prevents the seal member 26 from being detached from the housing 28. The restrictor 21 provides retaining surface 23 which is in direct opposition with the sealing surface 29. The seal member 26 is thereby constrained to only be movable between the sealing surface 29 (closed position) and the retaining surface 23 (open position). The restrictor 21 is secured in position within the inlet 22 of the valve housing 28. The restrictor 21 comprises a series of push fit legs 18 for engagement within corresponding recesses 19 defined around the inner surface of the inlet 22.

To assemble the inflation valve 20, the seal member 26 is placed within the inlet 22 and the restrictor 21 is then pushed into the inlet 22 until the push fit legs 18 engage within the corresponding recesses 19. In this configuration, the inflation valve 20 is forms a single component and the seal member 26 is constrained to only be translationally movable between the open position and the closed position. As explained above, due to the individual magnets 36 acting on the magnetic member 34, the seal member 26 will be bias towards the closed position unless a counteracting force overcomes this magnetic attractive force. Such a counteracting force may be created due to excessive internal pressure within the inflatable camping assembly or may be actuated through the use of a valve key 60 as will now be described.

The valve key 60 comprises a body 62 having a peripheral wall 64 and a number of apertures 66 provided on a partition 68 to create pathways through the body 62. The peripheral wall 64 is arranged to engage over an outer edge 27 of the inlet of the inflation valve 20. The valve key 60 includes a first seal 70 and a second seal 71 each of which comprise an annular seal. These seals 70, 71 locate on opposing sides of the partition 68. The seals 70, 71 are positioned to create a seal around the edge 27 of the inlet 22. In some embodiments, the valve key 60 may have different dimensions/diameters for the two seals 70, 71 to enable the valve key 60 to seal against two correspondingly different inlets 22. With such an arrangement, the internal diameter of one half of the body 62 may be reduced to engage around a smaller inlet 22.

The valve key 60 includes magnetic means in the form of a magnet 72 located and secured in a central position. Specifically, the partition 68 of the body 62 includes a central cylindrical opening 73 into which the magnet 72 is secured.

The valve key 60 is arranged to be positioned over the opening of the inlet 22 such that the seal 70 creates a seal around the edge 27. In this position, the magnet 72 of the valve key 60 will attract magnetic means provided on the movable seal member 26. In particular, the magnetic means of the seal member 26 comprises a core component 40 in the form of a central ferrous core. With the valve key 60 secured to the inlet 22, the magnet 72 attracts the core component 40 which thereby moves the seal member 26 to the open position. The magnetic force of the magnet 72 with the core component 40 is greater than the magnetic force between the individual magnets 36 and the magnetic member 34 such that the magnetic member 34 is pulled away from the individual magnets 36. This moves the seals 32, 33 away from the sealing surface 29 and creates an air pathway between the inlet 22 and the outlet 24.

Accordingly, the valve key 60 can be quickly and easily engaged in the inlet 22 to open the inflation valve 20. The valve key 60 may be engaged on the opposing (exposed) side with an air source. For example, the outlet of a pump may be engaged in the exposed face of the valve key 60. Accordingly, air can be easily introduced into the inflatable camping assembly through the use of the valve key 60. In addition, the inflation valve 20 prevents the easy opening of the valve, for example by a passer-by. This thereby restricts the use of the inflation valve 20. In addition, once engaged, the valve key 60 on its own can be left to help with the deflation since this will maintain the seal member 26 in an open position.

Further embodiments of the present invention will now be described in which different bias means are used to position the seal member and different systems are used to dock the valve key in the inflation valve. With these embodiments, like features will use like reference numbers incremented by 100 relative to the previous embodiment.

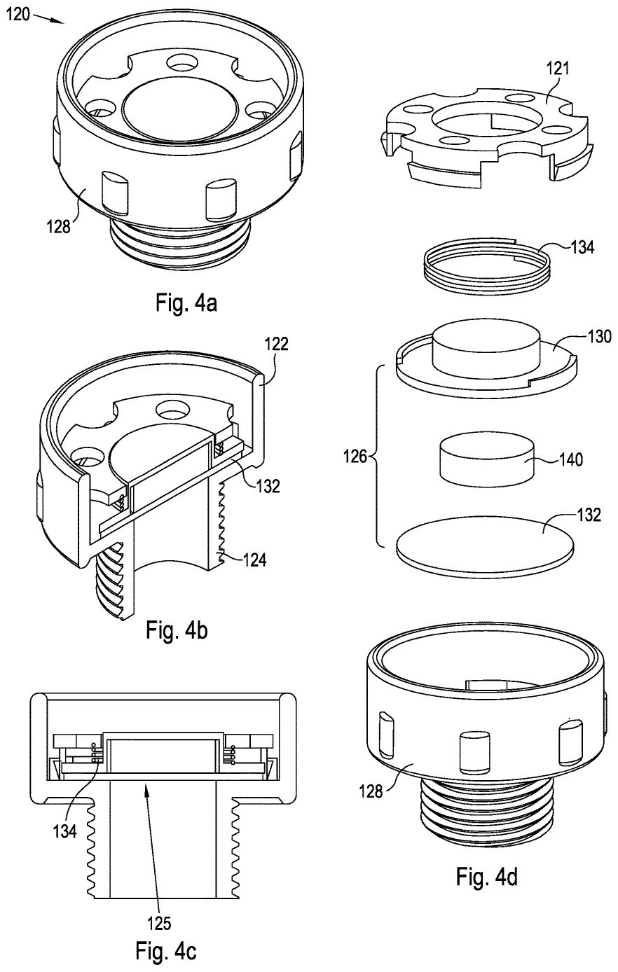

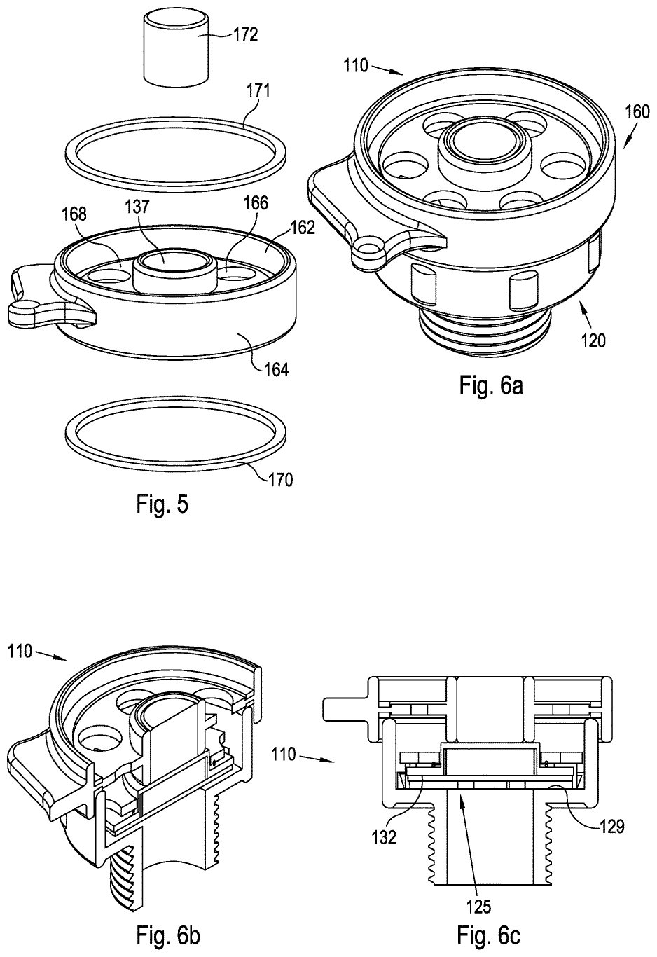

As shown in FIGS. 4-6, in the second embodiment, in the inflation valve assembly 110, the bias means comprises spring means to create the biasing force to maintain and/or urge the seal member 126 against the sealing surface (i.e. to a default closed position). The second embodiment retains the magnetic arrangement to dock the valve key 160 with the inflation valve 120.

The valve key 160 is essentially the same as that described for the first embodiment. However, in the inflation valve 120, a spring 134 is utilised to urge the seal member 126 towards the sealing surface 129. The spring 134 comprises a single coiled (helical) spring which is positioned between the upper/proximal surface of the carrier 130 and the lower/distal surface of the restrictor 121. Accordingly, the spring 134 pushes the seal member 126 towards the sealing surface 129 and is configured to create a seal over the opening 125 of the outlet 124.

The seal member 126 comprises a single seal element 132 comprising a disc (an elastomeric/resilient disc) which is arranged to locate over the opening 125 and to seal against the sealing surface 129 located around the periphery of the opening 125. The strength of the spring 134 is selected to seal the pressure within the inflatable camping assembly to a preferred level such that excessive pressure will overcome the bias effect of the spring 134 and move the seal member 126 away from the opening 125 to enable such excessive pressure to be released. In addition, the spring strength is insufficient to counteract the magnetic force generated with the use of the valve key 160.

As before, the valve key 160 is docked in and around the inlet 122 of the inflation valve 120. The magnet 172 located within the valve key 160 attracts the core component 140 in the form of a ferrous core secured on the seal member 126. This force is sufficient to overcome the counteracting force of the spring 134 which is maintaining the seal member 126 in the sealing/closed position. This movement lifts the seal member 126 away from the sealing surface 129 and thereby opens a pathway through the valve assembly 110. In this position, air can be introduced into the inflatable camping assembly by an air source (pump etc.) in order to inflate the inflatable camping assembly. Alternatively, air is able to freely escape to the atmosphere from the inflatable camping assembly in order to deflate the inflatable camping assembly. As before, the valve key 160 is specifically required in order to easily open/close the inflation valve 120 which thereby offers a level of protection for the owner/user of the inflatable camping assembly.

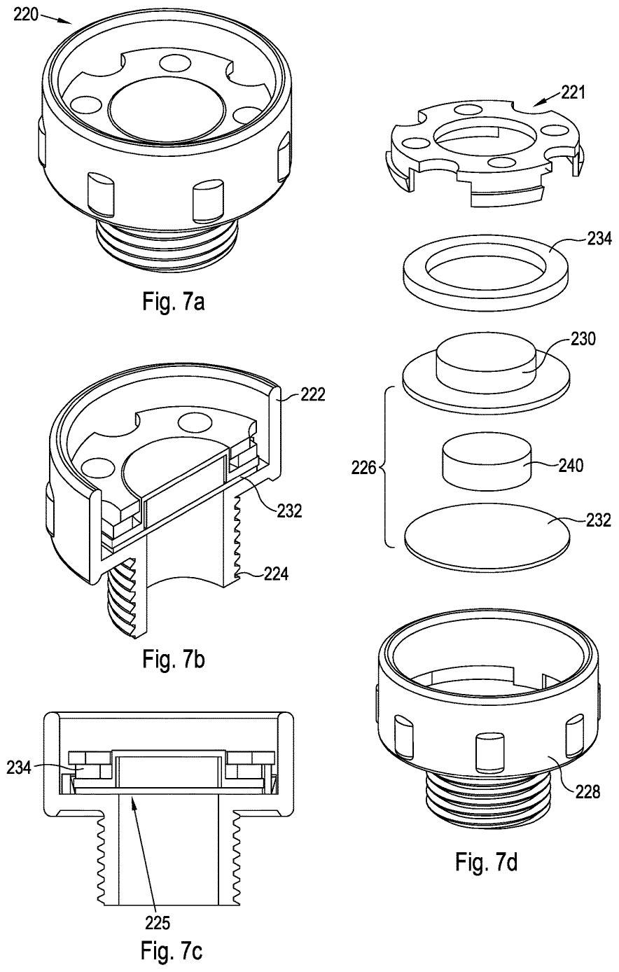

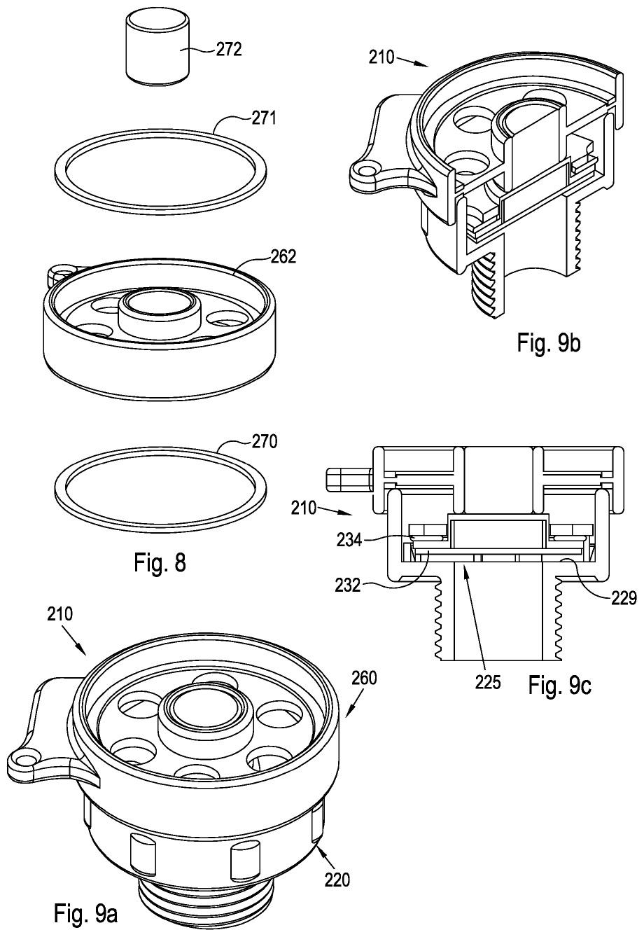

As shown in FIGS. 7-9, in the third embodiment, in the inflation valve assembly 210, the bias means comprises resilient means to create the biasing force to maintain and/or urge the seal member 226 against the sealing surface (i.e. to a default closed position). The third embodiment retains the magnetic arrangement to dock the valve key 260 with the inflation valve 220.

The valve key 260 is essentially the same as that described for the first embodiment. However, in the inflation valve 220, a resilient member 234 is utilised to urge the seal member 226 towards the sealing surface 229. The resilient member 234 comprises a single annular resilient element which is positioned between the upper/proximal surface of the carrier 230 and the lower/distal surface of the restrictor 221. Accordingly, the resilient member 234 pushes the seal member 226 towards the sealing surface 229 and is configured to create a seal over the opening 225 of the outlet 224.

The seal member 226 comprises a single seal element 232 comprising a disc (an elastomeric/resilient disc) which is arranged to locate over the opening 225 and to seal against the sealing surface 229 located around the periphery of the opening 225. The resilient strength of the resilient member spring 234 is selected to seal the pressure within the inflatable camping assembly to a preferred level such that excessive pressure will overcome the bias effect of the resilient member 234 and move the seal member 226 away from the opening 225 to enable such excessive pressure to be released. In addition, the resilient strength is insufficient to counteract the magnetic force generated with the use of the valve key 260.

As before, the valve key 260 is docked in and around the inlet 222 of the inflation valve 220. The magnet 272 located within the valve key 260 attracts the core component 240 in the form of a ferrous core secured on the seal member 226. This force is sufficient to overcome the counteracting force of the resilient member 234 which is maintaining the seal member 226 in the sealing/closed position. The magnetic force essentially squashes the material of the resilient member 234 as the seal member 226 is moved to the open position. Conversely, the resilient member 234 will regain its original shape and configuration on removal of the magnetic force created by the valve key 260. This docking action of the valve key 260 lifts the seal member 226 away from the sealing surface 229 and thereby opens a pathway through the valve assembly 210. In this position, air can be introduced into the inflatable camping assembly by an air source (pump etc.) in order to inflate the inflatable camping assembly. Alternatively, air is able to freely escape to the atmosphere from the inflatable camping assembly in order to deflate the inflatable camping assembly. As before, the valve key 260 is specifically required in order to easily open/close the inflation valve 220 which thereby offers a level of protection for the owner/user of the inflatable camping assembly.

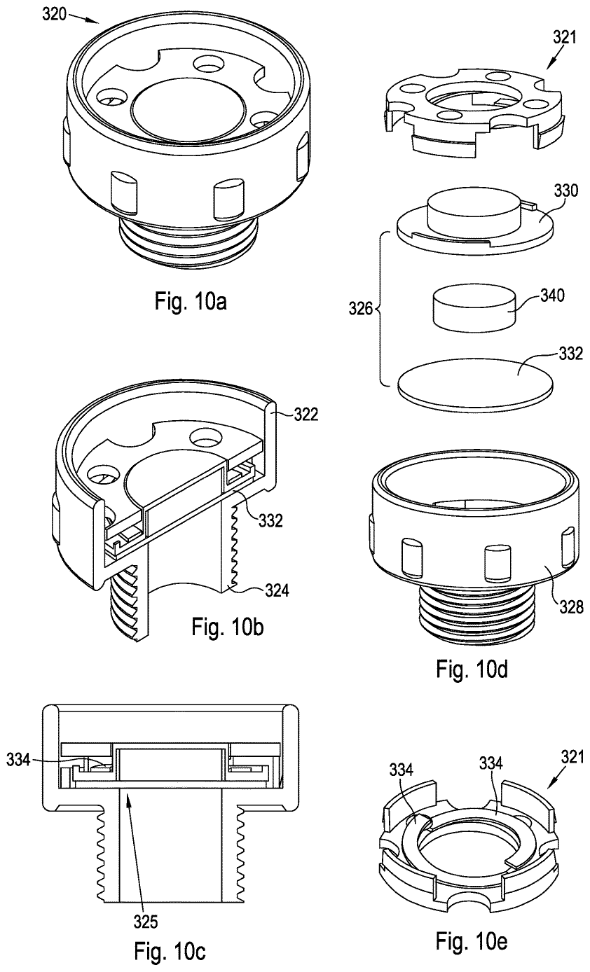

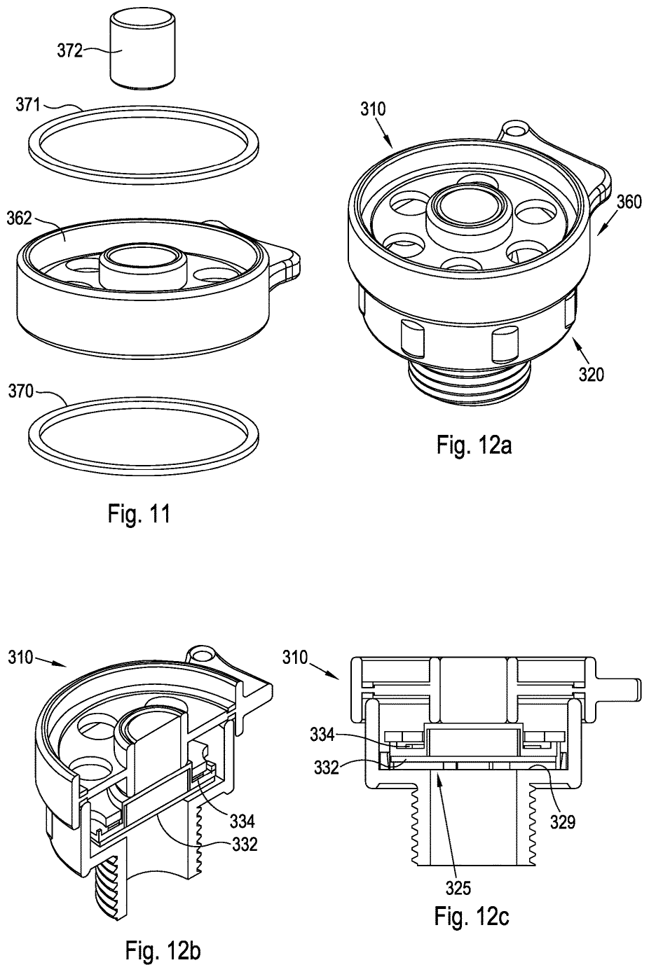

As shown in FIGS. 10-12, in the fourth embodiment, in the inflation valve assembly 310, the bias means again comprises spring means to create the biasing force to maintain and/or urge the seal member 326 against the sealing surface (i.e. to a default closed position). The fourth embodiment retains the magnetic arrangement to dock the valve key 360 with the inflation valve 320.

The valve key 360 is essentially the same as that described for the first embodiment. However, in the inflation valve 320, spring means in the form of leaf springs 334 or tendrils are utilised to urge the seal member 326 towards the sealing surface 329. The spring means comprises two leaf springs 334 which are arcuate and extend through approximately 180 degrees. One end of each leaf spring 334 is attached or secured to the distal surface/underside of the restrictor 321 as shown in FIG. 10e. Each leaf spring 334 has a free end which will abut a proximal/upper surface of the carrier 330. The leaf springs 334 are thereby between the upper/proximal surface of the carrier 330 and the lower/distal surface of the restrictor 321. Accordingly, the leaf springs 334 push the seal member 326 towards the sealing surface 329 and are configured to create a seal over the opening 325 of the outlet 324.

The seal member 326 comprises a single seal element 332 comprising a disc (an elastomeric/resilient disc) which is arranged to locate over the opening 325 and to seal against the sealing surface 329 located around the periphery of the opening 325. The strength of the leaf springs 334 is selected to seal the pressure within the inflatable camping assembly to a preferred level such that excessive pressure will overcome the bias effect of the leaf springs 334 and move the seal member 326 away from the opening 325 to enable such excessive pressure to be released. In addition, the spring strength is insufficient to counteract the magnetic force generated with the use of the valve key 360.

As before, the valve key 360 is docked in and around the inlet 322 of the inflation valve 320. The magnet 372 located within the valve key 360 attracts the core component 340 in the form of a ferrous core secured on the seal member 326. This force is sufficient to overcome the counteracting force of the leaf springs 334 which is maintaining the seal member 326 in the sealing/closed position. This movement lifts the seal member 326 away from the sealing surface 329 and thereby opens a pathway through the valve assembly 310. This flexes or bends the leaf springs 334 which retain the bias effect for use after the removal of the valve key 360. In this position, air can be introduced into the inflatable camping assembly by an air source (pump etc.) in order to inflate the inflatable camping assembly. Alternatively, air is able to freely escape to the atmosphere from the inflatable camping assembly in order to deflate the inflatable camping assembly. As before, the valve key 360 is specifically required in order to easily open/close the inflation valve 320 which thereby offers a level of protection for the owner/user of the inflatable camping assembly.

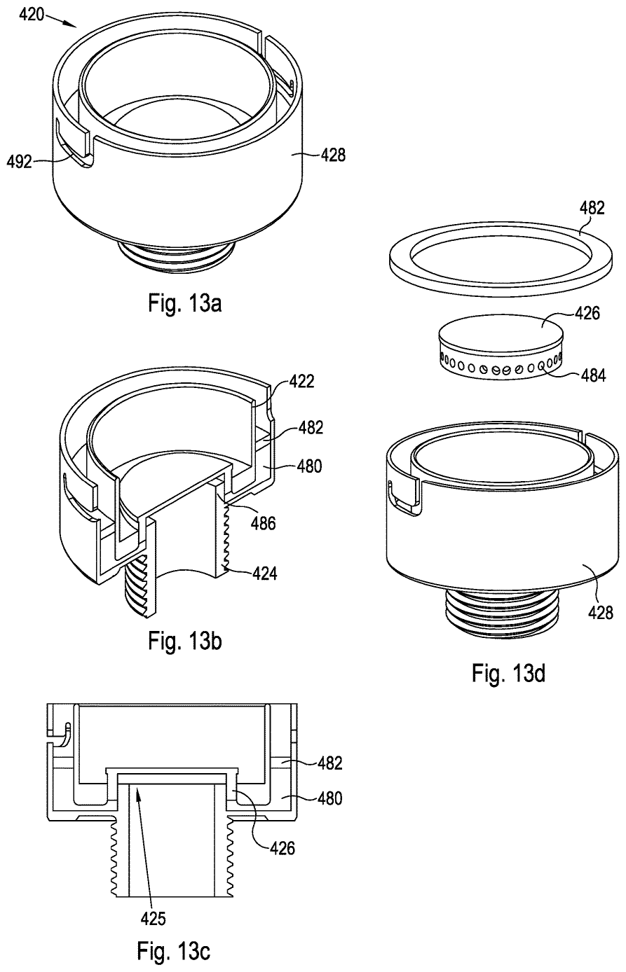

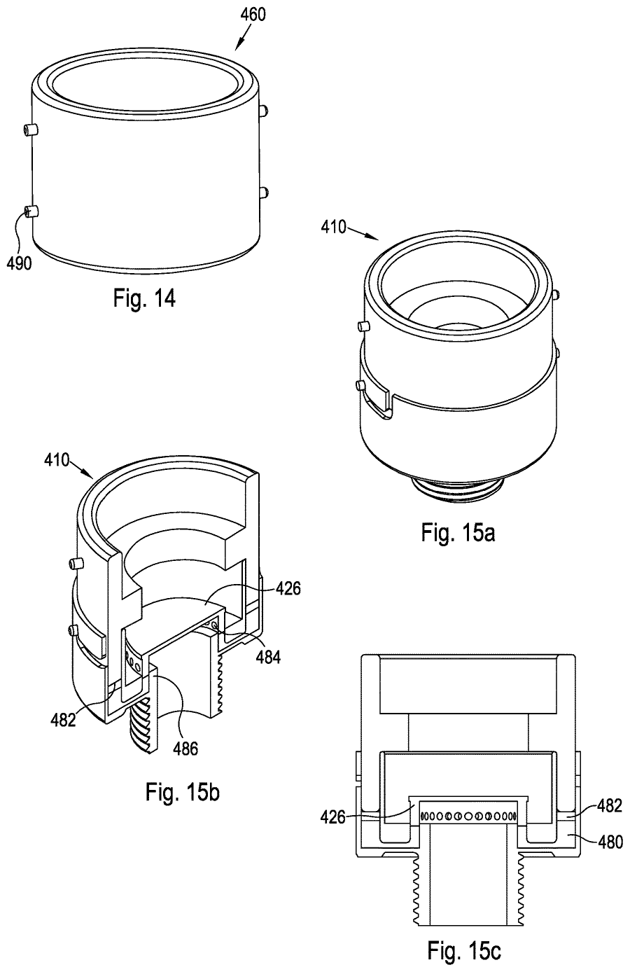

As shown in FIGS. 13-15, in the fifth embodiment, in the inflation valve assembly 410, the bias means comprises a fluid chamber to create the biasing force to maintain and/or urge the seal member 426 into a sealing position (i.e. to a default closed position). The fifth embodiment uses a bayonet arrangement to dock the valve key 460 with the inflation valve 420.

The inflation valve 420 comprises a fluid chamber 480 defined between a membrane 482 and the movable seal member 426. The seal member 426 also provides a skirt including a series of openings 484 which are used to create the required air pathway through the valve assembly 410. In the default position, the seal member 426 is positioned such that the openings 484 are concealed below an upper extending surface 486 of the opening 425 of the outlet 424. Accordingly, air is unable to pass through the valve assembly 410. A force is required to move the seal member 426 to an open position which would thereby expose the openings 484 above the upper edge of the upper extending surface 486 of the opening 425 of the outlet 424. This movement is created by the dedicated valve key 460 as will now be explained.

The valve key 460 comprises two lugs 490 which extend outwardly therefrom and are offset by 180 degrees. These lugs 490 are arranged to be engaged within two corresponding slots 492 defined on the housing 428 of the inflation valve 420. This creates a bayonet arrangement whereby the valve key 460 is docked in the inflation valve 420. The lower/distal edge of the valve key 460 passes down an annulus provided by the inflation valve 420 until the lower/distal edge contacts/abuts the membrane 482. The lower/distal edge moves/deflects the membrane 482 downwardly/distally which increases the pressure and/or displaces the fluid within the fluid chamber 480. This causes the fluid to act on the lower/distal edge of the seal member 426 which thereby moves the seal member 426 upwardly to expose the openings 484. Accordingly, in this position, an air pathway is created through the inflation valve assembly 410.

On removal of the valve key 460 from the bayonet docking arrangement, the membrane 482 will regain its original position/configuration such that the seal member 426 automatically returns to the default (closed) position.

As before, the valve key 460 is specifically required in order to easily open/close the inflation valve 420 which thereby offers a level of protection for the owner/user of the inflatable camping assembly.

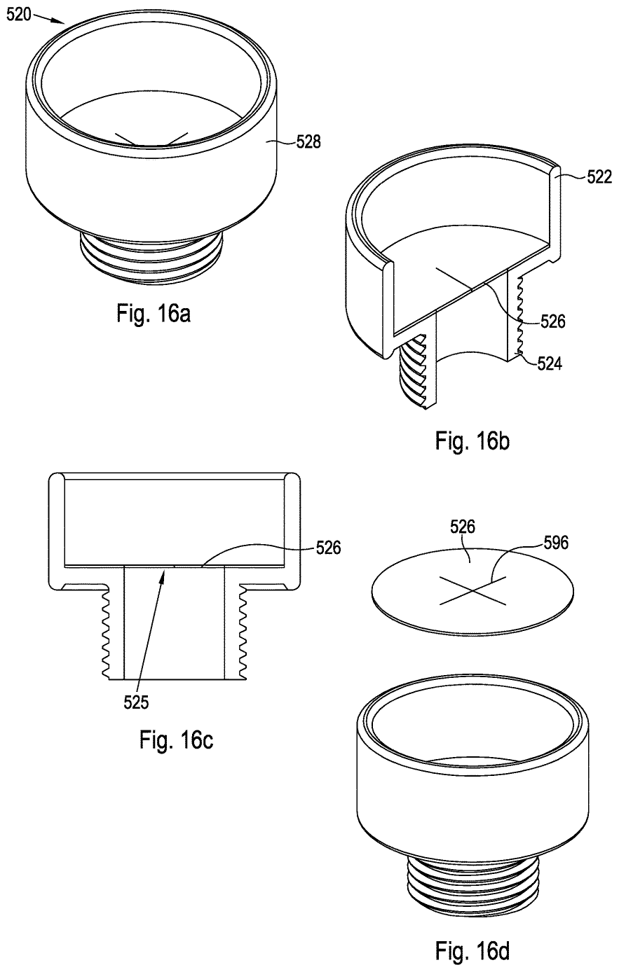

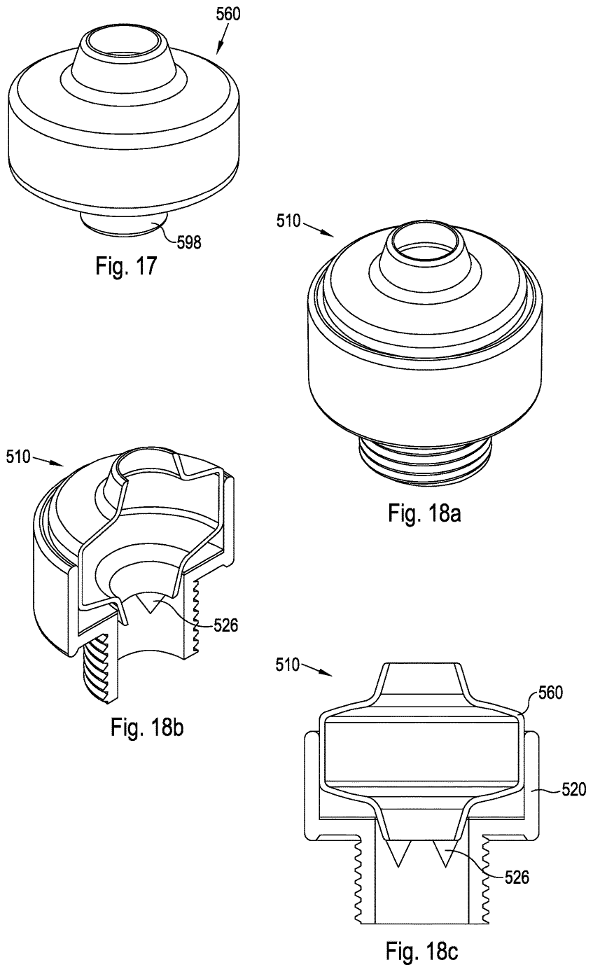

As shown in FIGS. 16-18, in the sixth embodiment, in the inflation valve assembly 510, the bias means comprises a deformable sealing membrane which naturally maintains the seal member 426 against the sealing surface (i.e. to a default closed position).

In the inflation valve 520, a resilient deformable membrane provides the seal member 526 and includes sealing flaps 596 which are movable between an open position and a closed position. The resilient material of the sealing flaps 596 causes the flaps 596 to bias towards the closed position such that a positive force is required to move these flaps 596 away from the closed position. In this embodiment, there are four flaps 596 created by and intersecting at a cross.

The seal member 526 comprises a single seal element comprising a membrane disc (an elastomeric/resilient disc) which is arranged to locate over the opening 525 and to seal the opening 525. The bias returning strength of the flaps 596 is selected to seal the pressure within the inflatable camping assembly to a preferred level such that excessive pressure will overcome the bias effect of the flaps 596 and move the flaps to create an opening which would enable such excessive pressure to be released.

As before, the valve key 560 is docked in the inlet 522 of the inflation valve 520. The valve key 560 is arranged to be docked with the inlet 522 using an interference fit to maintain the docking engagement between the valve key 560 and the inflation valve 520. In particular, the dimensions of an outer periphery of the valve key 560 and an inner periphery of the inlet 522 are selected together with the characteristics of the associated material to create the required interference fit.

The valve key 560 includes a nozzle 598 which is shaped to move the flaps 596 outwardly to create an opening through the inflation valve assembly 510. In particular, the nozzle 598 moves and deflects all four flaps 596 outwardly such that the (central) opening in the nozzle 598 locates through the membrane.

As before, the valve key 560 is specifically required in order to easily open/close the inflation valve 520 which thereby offers a level of protection for the owner/user of the inflatable camping assembly.

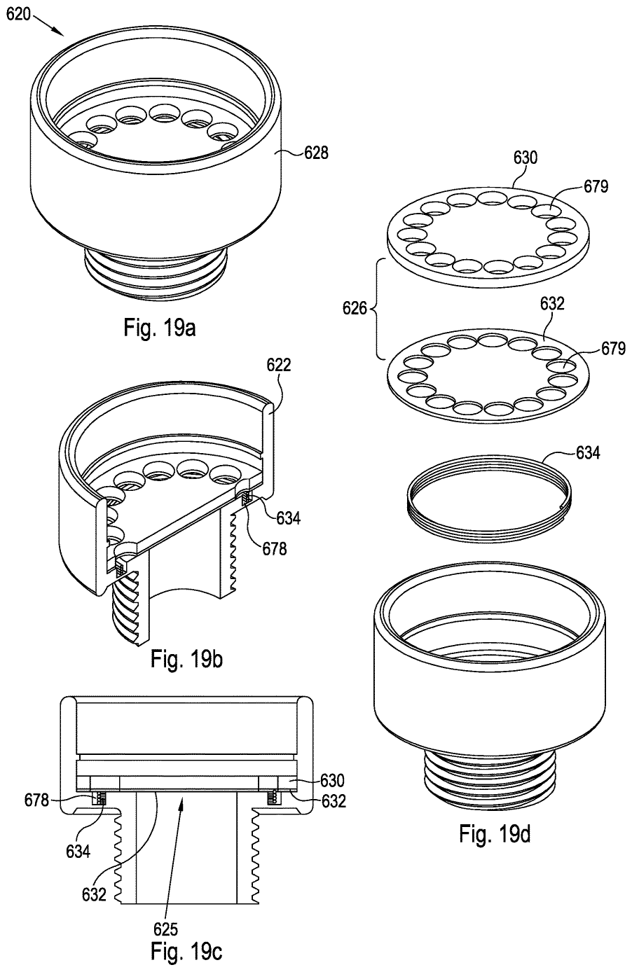

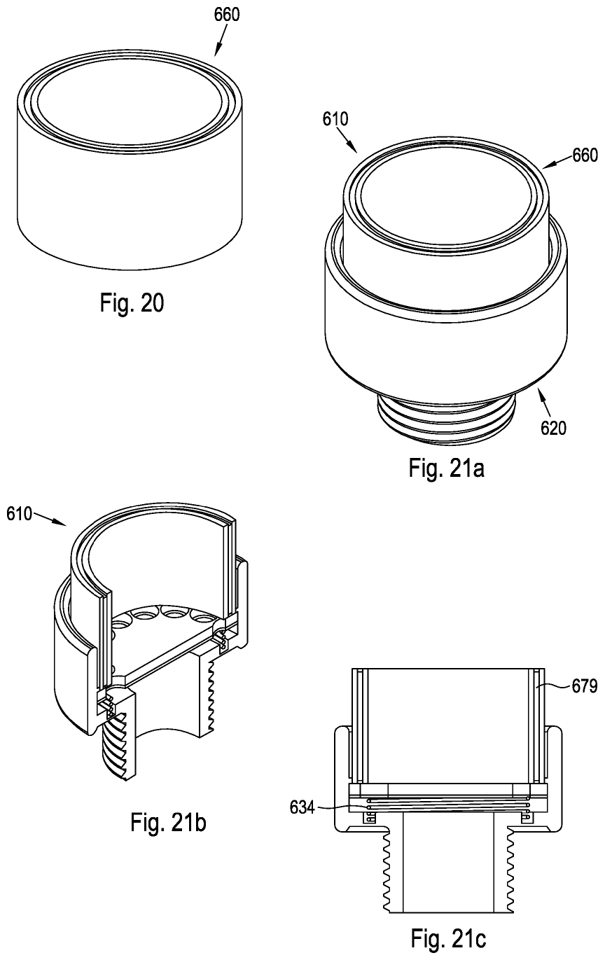

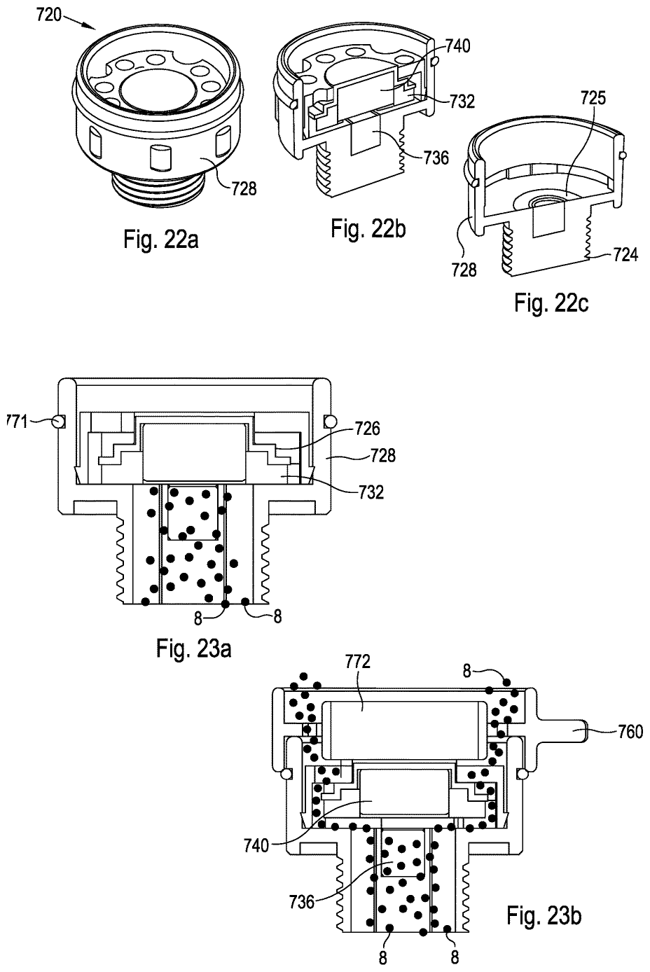

As shown in FIGS. 19-21, in the seventh embodiment, in the inflation valve assembly 610, the bias means comprises an expandable element 634 comprising a shape memory alloy to move the seal member 626 away from the default closed position which is naturally retained by the seal member 626 being biased towards the closed potion by gravity and/or by urging means (spring etc.) (not shown).

In the inflation valve 120, an expandable element 634 spring is utilised to urge the seal member 626 away from the sealing surface 629. The expandable element 634 comprises a single coiled (helical) element which is positioned within an annular recess 678 in the sealing surface 629. An upper surface of the expandable element 634 is able to contact a lower/distal surface of the seal member 626. Th expandable element comprises a shape memory alloy which at resting pressure is compressed. A catalyst material or feature of the valve key 620 is able to generate a change in temperature (heating), which in turn invokes the properties of the shape memory alloy, causing it to expand. This expansion elevates the seal member 626 to allow airflow.

The seal member 626 comprises a carrier 630 and a sealing element 632 (e.g. an elastomeric sealing element). The seal member 626 includes a series of openings 679 which will allow air to flow therethrough. In particular, when the seal member 626 is elevated away from the sealing surface 629 of the inflation valve, air will be able to flow through these openings 679.

As before, the valve key 660 is docked in and around the inlet 622 of the inflation valve 620. The valve key 660 is arranged to be docked with the inlet 622 using an interference fit to maintain the docking engagement between the valve key 660 and the inflation valve 620. In particular, the dimensions of an outer periphery of the valve key 660 and an inner periphery of the inlet 622 are selected together with the characteristics of the associated material to create the required interference fit.

The valve key 660 includes means to activate the shape memory alloy of the expandable element 634. The valve key 660 includes a central sleeve 679 of a material to facilitate this reaction. A lower end of this sleeve 679 is arranged to locate within a sufficient proximity to cause the expansion of the expandable element. For example, the lower end of the sleeve may locate within a distance to be able to transmit heat from the sleeve 679 to the expandable element 634 to thereby lift the seal member 626 to the open position. Accordingly, means to generate the required heat within the sleeve is also provided.

As before, the valve key 660 is specifically required in order to easily open/close the inflation valve 620 which thereby offers a level of protection for the owner/user of the inflatable camping assembly.

A further embodiment of the present invention is shown in FIGS. 22 and 23. In this embodiment, the inflation valve 720 includes bias means in the form of a (central) magnetic member 736 to maintain and/or urge the seal member 726 against the sealing surface (i.e. to a default closed position). The second embodiment also includes a magnetic arrangement to dock the valve key 760 with the inflation valve 720.

The valve key 760 is essentially the same as that described for the first embodiment. However, in the inflation valve 720, the seal member 726 comprises a single seal element 732 comprising a disc which may comprise an airtight composite which is seal over openings 725 of the outlet 724.

In FIGS. 23a and 23 b, the air is shown schematically with reference number 8 such that the air pathway through the assembly is illustrated in FIG. 23b. FIG. 23a illustrates the default closed position. In this embodiment, sealing means in the form of an outer O-ring seal 771 on the housing 728 of the inflation valve 720 is arranged to form a seal between the inflation valve 720 and the valve key 760.

The magnetic force between the magnetic member 740 (ferrous component) of the seal member 726 and the magnetic member 736 (magnet) of the inflation valve 720 is less than the magnetic attractive force between the magnetic member 772 (magnet) of the valve key 760 and the magnetic member 740 (ferrous component) of the sealing member 726 such that the docking of the valve key 760 opens and retains the inflation valve 720 in an open position/configuration. Specifically, the magnetic member 772 of the valve key 760 acts in a directly opposite way and retracts the magnetic member 740 of the seal 726 member away from the magnetic member 736 of the inflation valve 720. In one example, the magnetic attractive force of the valve key 760 may be substantially 15 kg whereas the magnetic attractive force of the magnetic member 736 in the valve housing 728 may be substantially 2.5 kg. A greater value of magnetic force in the order or 4, 6, 10 or more times thereby establishes a reliable method of ensuring that the seal member 726 moves to the open position but that the default closing force is still sufficient to withhold internal pressure in the order of 8 psi in some examples.

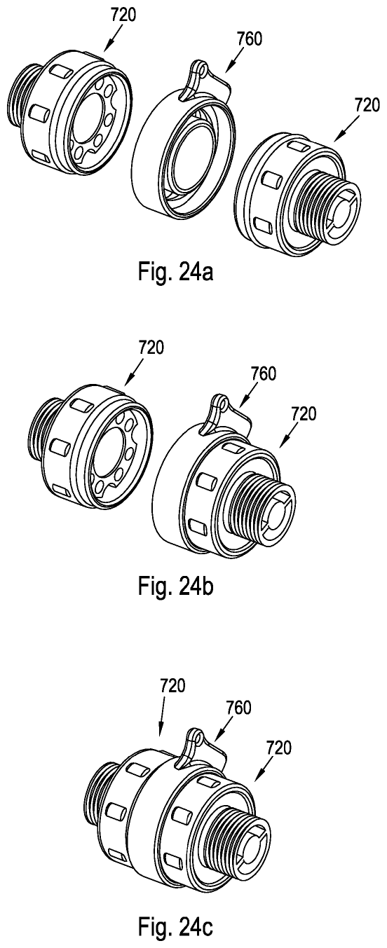

As shown in FIG. 24, in preferred embodiments, the valve key 760 is arranged to be dual sided such that a first side of the valve key 760 may dock with a first inflation valve 720 and a second side may dock with a second inflation valve 720. Accordingly, in such an arrangement, a first inflatable camping assembly may be arranged to inflate a second inflatable camping assembly. In such a system, one inflatable camping assembly acts as the air source for the other inflatable camping assembly. More specifically, a first camping assembly acts as a donor to the second camping assembly.

In this donor arrangement, the valve key 760 maintains two seal members in open configurations throughout the connection. In particular, for some embodiments, the central magnet will attract a first seal member of a first inflation valve 720 and also a second seal member of a second inflation valve 720. As it will be appreciated, each embodiment described above (and shown in the accompanying figures) may be used to provide this dual functionality.

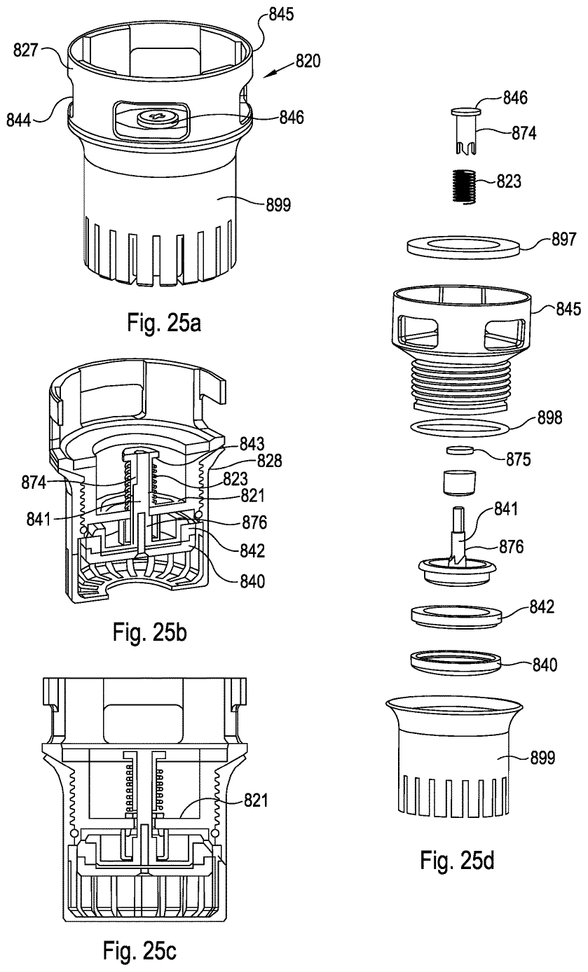

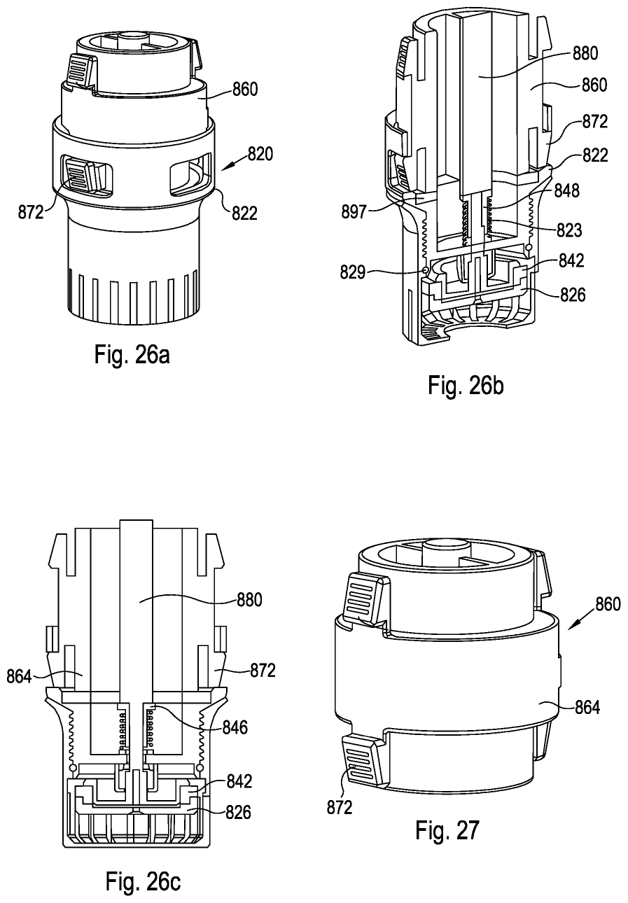

Another preferred embodiment of an inflation valve 820 and a corresponding valve key 860 is shown in FIGS. 25 to 27. In this embodiment, the inflation valve 820 includes bias means in the form of a spring 823 to maintain and/or urge the seal member 826 against the sealing surface (i.e. to a default closed position). The inflation valve 820 includes a docking arrangement to dock the valve key 860 with the inflation valve 820 and to maintain the inflation valve 820 in an open position.

The valve key 860 includes engagement means in the form of resilient tabs 872 to provide an engagement/docking function. Specifically, the peripheral wall 864 of the valve key 860 provides a first pair of resilient tabs 872 for engagement with the inflation valve 820. In some embodiments the valve key 820 may also include a second pair of resilient tabs 872 for engagement with a second inflation valve and/or to enable either end of the valve key 820 to be used. The tabs 872 are provided towards an end of the valve key 860. The inflation valve 820 comprise engagement means in the form of openings 844 or recesses. Specifically, the inflation valve 820 provides two openings 844 which are offset by 180 degrees around the outer or peripheral walls 827 of the inlet 822. In some embodiments, there may be four openings 844 each offset by 90 degrees such that the valve key 860 can be more easily engaged due to the two resilient tabs 872 being engageable in two different pairs of openings 844, for example, the valve key 860 can be located in the inlet 822 and then rotated until the tabs 872 engage in the closest pair of openings 844.

In use, the valve key 860 is docked and engaged with the inflation valve 820 and in a receiving portion 845. A leading/distal end of the valve key 860 forms a seal with a sealing member 897 (O-ring seal) provided in the receiving portion 845. This attachment causes the seal member 826 to move to an open position. In particular, the actuator 880 of the valve key 860 pushes and moves the seal member 826 to an open position. Specifically, the actuator 880 of the valve key 860 presses the restrictor 841 downwardly to open the inflation valve 820. The detachment of the valve key 860 from the inflation valve 820 will then release the pressure on the restrictor 841 and the inflation valve 820 will close.

The seal member 826 comprises a carrier 840 and a restrictor 841 which secures the carrier 840 within the inlet 822. The seal member 826 also comprise a seal which in this embodiment comprises a primary seal 842. The primary seals 842 comprise an annular seal (e.g. elastomeric O-ring seal).

The inflation valve 820 includes bias means in the form of a coiled spring 823 located around a central shaft 848 (core member) which urges and moves the seal member 826 towards the sealing surface 829. Specifically, this biasing arrangement causes the primary seal 842 to seal against the sealing surface 829. The coiled spring 823 is restrained between a retaining surface of the carrier and a face 821 in the inlet 822 of the inflation valve 820. The restrictor 841 comprises a shaft (or core member) which extends from the disc shaped portion of the carrier 840 and the shaft projects through the inlet face 821 of the inflation valve 820. The inlet face 821 provides an aperture or path through a disc shaped partition providing the inlet face 821. The aperture enables the shaft 848 to slidably move therein. At an upper distal end of the shaft 848, a head 846 is provided which comprises an enlarged head or radial flange. The enlarged head has a diameter or periphery which is too large to pass through the aperture. The enlarged head 846 thereby provides an annular surface or retaining surface 843 in direct opposition to the upper/distal surface of the inlet face 821. These two opposing surfaces are arranged to trap or restrain a spring 823 therebetween in order to urge the seals 832 against the sealing surface 829.

The restrictor 841 of the inflation valves 820 is also arranged to restrict the movement of the seal member 826. Specifically, the restrictor 841 prevents the seal member 826 from being detached from the housing 828. The restrictor 841 provides a retaining surfaces 843 which is in direct opposition to an outer surface of the face 821 (located in the inlet 822) of the inflation valves 820. The seal member 826 is thereby constrained to only be movable between the sealing surface 829 (closed position) and a restricted position spaced apart from the sealing surface 829 which thereby creates a gap to allow air to flow around the seal member 826. The restrictor 841 is secured in position within the inlet 822 of the valve housings 828. The restrictor 841 comprises a central shaft with an upper (distal) head or flange. The head (or flange) provides the surface 843 to engage with the coiled spring 823. In addition, the upper distal end surface of the head provides a contact surface for actuating the inflation valve 820. In one embodiment, the shaft comprises two parts to enable the coiled spring 823 to be located in position on a lower component prior to engagement with the upper component including the head is subsequently attached or connected which thereby retains the coiled spring 823 in position. These two components forming the shaft may be secured together with a push fit arrangement. The inflation valve 820 also includes a (inner) shroud housing 899 which secures to the body of the inflation valve through a sealing member 898 (O-ring seal) and a screw thread arrangement.

The inflation valve 820 includes latching means which is manually operable and enables a user to press a part of the seal member 826 in order for the seal member to be engaged with the latching means which preferably subsequently retains the seal member 826 in the open position or in a second open position. For example, the seal member 826 is held in the closed position when the seal member is unlatched and the seal member 826 is not being pressed by the valve key 860 (or any other external force) and is held in the open position by the valve key 860 and is held in a second open position by the latching means. In the two open positions, the bias means (spring 823) continues to bias and urge the seal member 826 back towards the closed position. The latching means is manually operable from the latched position to be unlatched by a user pressing a part (e.g. the head 846) of the seal member 826 in order for the seal member 826 to disengage with the latching means which subsequently enables the seal member 826 to move to the closed position. The latching means comprises a latch in the form of a ring component 875. The ring component 875 engages with a profiled surface provided on a first section 874 of a restrictor 841 and a second section 876 of the restrictor 841. The or each profiled surface comprises a series of gaps or recesses for the ring 875 (or a part of the ring) to engage within in order to engage or disengage the seal member 826 in a latched (open or second open) position.

The latching means is not operable by the valve key 860. Specifically, the latching means is not operated by the docking of the valve key 860 within the inflation valve 820. The valve key 860 only moves the restrictor 841 partially towards the latching means such that the latching means is not able to latch the seal member 826 and the seal member 826 remains unlatched. Specifically, when a user presses the restrictor 841 inwardly, a part of the seal member 826 provides a resistive force to indicate when a fully depressed position has been reached such that the user can remove the pressing force and the seal member 826 will remained latched in the open (or second open position). When the valve key 860 is docked, the seal member does not reach this fully depressed position and only travels partially towards this depressed position such that the latch is not operated and, on removal of the valve key 860, the seal member 826 automatically and immediately returns (due to the bias mean in the form of the spring 823) to the closed position since there is not latch or other obstruction to retain the seal member 826 in the open or second open position (or any open position). In the latched position, the bias means (spring 823) will continue to bias the seal member 826 towards the closed position.

Accordingly, in this embodiment, a user may also be able to operate the inflation valve 820 manually without the valve key 860. When the valve key 860 is not docked with the inflation valve 820, a user may press the restrictor 841 to open or close the inflation valve 820. The seal member valve 826 provides a shaft which includes a first (upper distal) section 874 and a second (lower/proximal) section 876. These sections operate with a ring 875 to provide a latch or catch mechanism to assist in maintaining the seal member 826 in an open position. This retaining mechanism may assist in deflation. As it will be appreciated, when the seal member 826 is pushed inwardly (downwardly) the seal 829 disengages from the associated sealing surface on the valve to allow fluid flow, for example, to allow inflation or deflation.

The upper section 874 is a stationary part and does not twist or rotate. The whole seal member 826 is pressed down and the upper section 874 contacts the ring causing the ring to twist. When the downwards force is released (e.g. the user's finger is released) from pressing the seal member 826, the ring 875 will fall into a slot on the lower section 876. The slots on the lower section 876 determine whether the lower section will seal the valve or open the valve, by determining the height of the lower section 876 within the valve. The slots are (alternately) sequenced as every other, so for example slot 1=valve open, slot 2=valve close, slot 3=valve open, slot 4=valve closed. The spring 823 forces the upper section 874 upwardly so that the ring 875 is forced into the next slot, determining whether the valve is open or closed. The ring 875 will continue to rotate around in the same direction every time the seal member 826 is pressed. This latching mechanism is not activated by the valve key 860 since the valve key 860 does not completely press the restrictor 841 down to engage the ring 875 and therefore the inflation valve 820 (seal member 826) will revert back to the closed position when valve key 60 is released.

Overall, the present invention addresses a problem through the use of the default position of valves being closed, therefore they are always ready for set-up when the camping structure is unpacked, rather than each valve having to be manually closed prior to inflation. With such a configuration, user intervention is not required to arrange the inflation valve to be closed, for example, a stopper is not required to be placed with the valve. The valve key inhibits malicious deflation, whilst facilitating a donor system, with the valves themselves automatically purging excess air pressure to negate over inflation and potential costly bursting of the tent.

1. An inflation valve assembly comprising:
an inflation valve comprising:
an inlet;
an outlet; and
a seal member which is movable between an open position and a closed position, the seal member comprising a seal to prevent or allow air flow through inflation valve between the inlet and the outlet, the seal member being biased away from the open position and towards the closed position by a bias arrangement;
a valve key;
wherein the valve key is configured to be docked with the inlet of the inflation valve to move the seal member to the open position and an engagement arrangement are arranged to engage the valve key in this docked position, in the docked position the valve key maintains the seal member in the open position to create an air pathway through the inflation valve between the inlet and the outlet.

2. An inflation valve assembly according to claim 1 in which the inflation valve assembly comprise a magnetic docking arrangement to retain the valve key to the inflation valve and to move the seal member from the closed position to the open position.

3. An inflation valve assembly according to claim 1 in which the default position of the seal member is in a closed position and is solely moved to, and retained in, an open position due to the docking of the valve key with the inflation valve.

4. An inflation valve assembly according to claim 1 in which the valve key comprises a magnetic key member.

5. An inflation valve assembly according to claim 1 in which the valve key has a face for connection with an air source.

6. An inflation valve assembly according to claim 1 in which the face is left exposed to allow air to pass through the inflation valve and out through the face of the valve key.

7. An inflation valve assembly according to claim 1 in which the valve key may comprise a seal member to create a seal against the inflation valve.

8. An inflation valve assembly according to claim 1 in which the valve key comprises a first docking face and a second docking face on opposing sides of the valve key.

9. An inflation valve assembly according to claim 1 in which the inflation valve comprises a magnetic valve member and in which the magnetic valve member is arranged to attract a magnetic key member of e valve key in order to dock the valve key with the inlet of the inflation valve.

10. (canceled)

11. An inflation valve assembly according to claim 9 in which the magnetic key member and the magnetic valve member provide a magnetic latch to retain the valve key to the inflation valve.

12. An inflation valve assembly according to a claim 9 in which the magnetic valve member is provided on the seal member.

13. An inflation valve assembly according to claim 12 in which the magnetic valve member is located with a carrier of the seal member and latching of the magnetic valve member with the magnetic key member moves the seal member from the closed position to the open position.

14. An inflation valve assembly according to claim 1 in which the bias comprises a magnetic bias arrangement to bias the seal member towards the closed position, in which the magnetic bias arrangement comprises a first member in a housing of the inflation valve and a second member provided on the seal member, in which the magnetic bias arrangement retains the seal member in the closed position unless a counteracting force is greater than the magnetic strength of the magnetic bias arrangement and, in which a strength of a magnetic docking arrangement is greater than the strength of the magnetic bias arrangement.

15. (canceled)

16. (canceled)

17. (canceled)

18. An inflation valve assembly according to claim 1 in which the bias arrangement comprises a spring bias arrangement comprising a spring arrangement to bias the seal member towards the closed position.

19. An inflation valve assembly according to claim 1 in which the bias arrangement comprises a fluid chamber having a first end which is acted on by a part of the valve key and a second end of the fluid chamber is in communication with the seal member wherein pressure from the valve key at the first end of the chamber is transmitted through the fluid within the chamber and acts of the seal member.

20. An inflation valve assembly according to claim 1 in which the inflation valve comprises a shape memory device which is arranged to move the seal member from the closed position to the open position.

21. An inflation valve assembly according to claim 1 in which the inflation valve assembly comprises a second inflation valve whereby the valve key is arranged to be docked with the first inflation valve and also with the second inflation valve.

22. A camping assembly comprising an inflatable camping assembly comprising an inflation valve assembly comprising:
an inlet;
an outlet; and
a seal member which is movable between an open position and a closed position, the seal member comprising a seal to prevent or allow air flow through inflation valve between the inlet and the outlet, the seal member being biased away from the open position and towards the closed position by a bias arrangement;
the camping assembly further comprising a valve key;
wherein the valve key is configured to be docked with the inlet of the inflation valve to move the seal member to the open position and an engagement arrangement are arranged to engage the valve key in this docked position, in the docked position the valve key maintains the seal member in the open position to create an air pathway through the inflation valve between the inlet and the outlet.

23. A camping assembly according to claim 22 in which the camping assembly comprises a second inflatable camping assembly and the valve key is arranged to be docked to both an inflation valve of the first camping assembly and an inflation valve of the second camping assembly, and in which the valve key is arranged to move and retain a seal member of the first inflation valve in an open position and a seal of the second inflation valve in an open position.

24. (canceled)

25. A method if inflating an inflatable camping assembly, the inflatable camping assembly comprising an inflation valve assembly comprising:
an inflation valve comprising:
an inlet;
an outlet; and
a seal member which is movable between an open position and a closed position, the seal member comprising a seal to prevent or allow air flow through inflation valve between the inlet and the outlet, the seal member being biased away from the open position and towards the closed position by bias arrangement;
a valve key;
wherein the valve key is configured to be docked with the inlet of the inflation valve to move the seal member to the open position and an engagement arrangement are arranged to engage the valve key in this docked position, in the docked position the valve key maintains the seal member in the open position to create an air pathway through the inflation valve between the inlet and the outlet;
the method comprising docking and engaging the valve key with the inlet of the inflation valve and moving the seal member to an open position.
